(19) United States
(12) Patent Application Publication
(10) Pub. No.: US 2025/0295070 A1
(43) Pub. Date: Sep. 25, 2025

(54) BLOWER NOZZLE SYSTEM FOR SUPPLEMENTAL AIR IN A SUGARCANE HARVESTER

(71) Applicant: DEERE & COMPANY, Moline, IL (US)

(72) Inventors: Jae-Jae Young, Thibodaux, LA (US); Dusk S. Mixon, Thibodaux, LA (US); Matthew J. Hansen, Thibodaux, LA (US); Rushikesh Dakhore, Risod (IN)

(21) Appl. No.: 18/611,924

(22) Filed: Mar. 21, 2024

(51) Int. Cl. A01D 45/10; A01D 43/08

(52) U.S. Cl. CPC A01D 45/10; A01D 43/08

(57) ABSTRACT

A sugarcane harvester configured to cut sugarcane into a sugarcane mat having crop residue and billets. The sugarcane harvester includes a chopper defining a chopper axis, wherein the chopper is configured to cut the sugarcane mat into a chopped mat including sugarcane billets and crop residue and to discharge the chopped mat along a flow path. The sugarcane harvester includes a primary separator having a cleaning chamber and a fan to induce a primary flow of air within the cleaning chamber, wherein the primary flow of air separates crop residue from the sugarcane billets of the chopped mat. A supplemental air system, located between the chopper and the primary separator, includes a manifold having a constant cross-section along a length of the manifold to provide a manifold air flow to supplement the primary flow of air to separate the crop residue from the sugarcane billets.

### FIELD OF THE DISCLOSURE

The present invention generally relates to a harvesting machine, and more particularly to a system and method for harvesting sugarcane with a sugarcane harvesting machine.

### BACKGROUND

Agricultural equipment, such as a tractor or a self-propelled harvester, includes mechanical systems, electrical systems, hydraulic systems, and electro-hydraulic systems, configured to prepare fields for planting or to harvest crops.

Harvesters of various configurations, including sugarcane harvesters, have harvesting systems of various types. Harvesting systems for a sugarcane harvester, for example, include assemblies or devices for cutting, chopping, sorting, transporting, etc., and otherwise gathering and processing sugarcane plants. Typical harvesting assemblies, in different implementations, include a base cutter assembly (or “base cutter”), feed rollers, cutting drums, stalk collectors, and extractor fans etc.

To actively harvest crops, the sugarcane harvester gathers and processes material from rows of sugarcane plants. In the case of one type of sugarcane harvester, the gathered sugarcane stalks are cut into billets that move through a loading elevator to an elevator discharge, where the cut sugarcane billets are discharged to a collector, such as the sugarcane wagon. Leaves, trash, and other debris are separated from the billets and ejected onto the field.

In various harvesters, harvesting assemblies are hydraulically powered by an engine-driven pump or electrically powered by a generator or other electrical power supply. The harvesting assemblies include rotating drums that move the cut stalks toward a chopper. The rotating drums are driven by a hydraulic motor or an electric motor that rotationally drives the feed rollers to continuously move the billets to a fan for processing, and once processed, to the wagon or other container. The motors include splines that engage the roller to drive the roller about a rotational axis.

The sugarcane, once cut, forms what is known as a “mat” of sugarcane. The sugarcane harvester feeds the mat to a chopping section where it is chopped, including the stalks which are cut into segments. The sugarcane harvester advances the chopped sugarcane mat, which includes billets and crop residue (e.g., leafy material, such as leaves, roots, and field debris etc.) to a primary extractor that separates at least a portion of the crop residue from the billets. The primary extractor includes a fan assembly having a motor and blades to clean the sugarcane, that is, to remove the crop residue from the sugarcane billets. The removed crop residue is discharged to the ground or to a collection wagon.

### SUMMARY

In one implementation, there is provided a sugarcane harvester for harvesting a sugarcane crop including a chopper defining a chopper axis. The chopper is configured to cut a mat of sugarcane crop into a chopped mat including sugarcane billets and crop residue and to discharge the chopped mat along a flow path. A primary separator includes a cleaning chamber and a fan to induce a primary flow of air within the cleaning chamber, wherein the primary flow of air separates crop residue from the sugarcane billets of the chopped mat. A supplemental air system, located between the chopper and the primary separator, includes a manifold having a constant cross-section along a length of the manifold, wherein the manifold is configured to provide a manifold air flow directed toward the flow path of the chopped mat, and wherein the manifold air flow supplements the primary flow of air within the cleaning chamber to separate the crop residue from the sugarcane billets.

In some implementations, the supplemental air system includes a blower coupled to an inlet of the manifold to deliver pressurized air to the manifold to provide the manifold air flow, wherein the manifold directs the pressurized air delivered by the blower to the cleaning chamber.

In some implementations, the chopper includes counter rotating drums defining the chopper axis, wherein the manifold includes a manifold axis located generally parallel to the chopper axis.

In some implementations, the manifold includes a plenum having a cylinder defining an interior space having the constant cross-section and including a convex outside surface.

In some implementations, the manifold includes a plurality of nozzles extending from the convex outside surface, wherein each of the nozzles is aligned along the manifold axis.

In some implementations, each of the nozzles includes a rectangular channel having a first end extending externally from the convex outside surface and a second end extending into the interior space.

In some implementations, the first end of each of the nozzles incudes a rectangular aperture having an external terminating edge.

In some implementations, the manifold includes wherein the rectangular aperture of the first end defines an external plane and the plane is generally parallel to the manifold axis.

In some implementations, the manifold includes wherein the second end of each of the nozzles includes a rectangular aperture having an internal terminating edge located within the cylinder, wherein the internal terminating edge is inclined with respect to the manifold axis.

In some implementations, the rectangular aperture of the second end defines a plane inclined with respect to the manifold axis.

In some implementations, the second end of each of the nozzles includes a first side wall having a first length and a second sidewall having a second length longer than the first length, wherein the first side wall is closer to the inlet of the manifold than the second side wall.

In another implementation, there is provided a blower nozzle system for a sugarcane harvester including a cleaning chamber to clean chopped sugarcane and a chopper configured to discharge a chopped sugarcane mat along a flow path to the cleaning chamber. The blower nozzle system includes a manifold having a constant cross-section along a length of the manifold, wherein the manifold is configured to provide a manifold air flow directed toward the flow path of the chopped sugarcane mat. The manifold air flow supplements a primary flow of air within the cleaning chamber to separate crop residue from the sugarcane billets of the chopped sugarcane mat and the manifold is configured to provide a manifold air flow directed toward the flow path of the chopped sugarcane mat to separate the crop residue from the sugarcane billets.

In some implementations, the manifold includes a plenum having a cylinder defining an interior space including the constant cross-section and including a convex outside surface.

In some implementations, the manifold includes a plurality of nozzles extending from the convex outside surface, wherein each of the nozzles is aligned along the manifold axis.

In some implementations, each of the nozzles includes a rectangular channel having a first end extending externally from the convex outside surface and a second end extending into the interior space.

In some implementations, the first end of each of the nozzles incudes one of a rectangular aperture, an elliptical aperture, an oval aperture, or a square aperture, having an external terminating edge.

In some implementations, the rectangular aperture of the first end defines an external plane and the plane is generally parallel to the manifold axis.

In some implementations, the second end of each of the nozzles includes a rectangular aperture having an internal terminating edge located within the cylinder, wherein the internal terminating edges is inclined with respect to the manifold axis.

In some implementations, the rectangular aperture of the second end defines a plane inclined with respect to the manifold axis.

In a further implementation, there is provided a method for separating crop residue from sugarcane billets in a cleaning chamber of a sugarcane harvester. The method includes: chopping a mat of harvested sugarcane into a chopped mat including the sugarcane billets and the crop residue, wherein the chopped mat moves along a flow path toward the cleaning chamber; directing a supplemental flow of air toward the flow path of the chopped mat with a manifold having a constant cross-section along a length of the manifold; and separating billets from crop residue in the cleaning chamber with the supplemental flow of air and with a primary flow of air provided by a fan located adjacent to the cleaning chamber.

### BRIEF DESCRIPTION OF THE DRAWINGS

The above-mentioned aspects of the present invention and the manner of obtaining them will become more apparent and the invention itself will be better understood by reference to the following description of the implementations of the invention, taken in conjunction with the accompanying drawings.

FIG. 1 illustrates a side elevational view of a work vehicle, and more specifically, of an agricultural vehicle such as a sugarcane harvesting machine.

FIG. 2 illustrates a side sectional view of a primary extractor coupled to an elevator.

FIG. 3 illustrates a perspective sectional view of feed rollers, a cutter assembly, a supplemental air system, and a primary separator of a sugarcane harvesting machine.

FIG. 4 illustrates a perspective view of a blower nozzle system including a blower and a manifold.

FIG. 5 illustrates a cross-sectional view of manifold taken along the lines 5-5 of FIG. 4.

FIG. 6 illustrates a cross-sectional view of a manifold taken along the lines 6-6 of FIG. 4.

### DETAILED DESCRIPTION

For the purposes of promoting an understanding of the principles of the novel invention, reference will now be made to the implementations described herein and illustrated in the drawings and specific language will be used to describe the same. It will nevertheless be understood that no limitation of the scope of the novel invention is thereby intended, such alterations and further modifications in the illustrated devices and methods, and such further applications of the principles of the novel invention as illustrated therein being contemplated as would normally occur to one skilled in the art to which the novel invention relates.

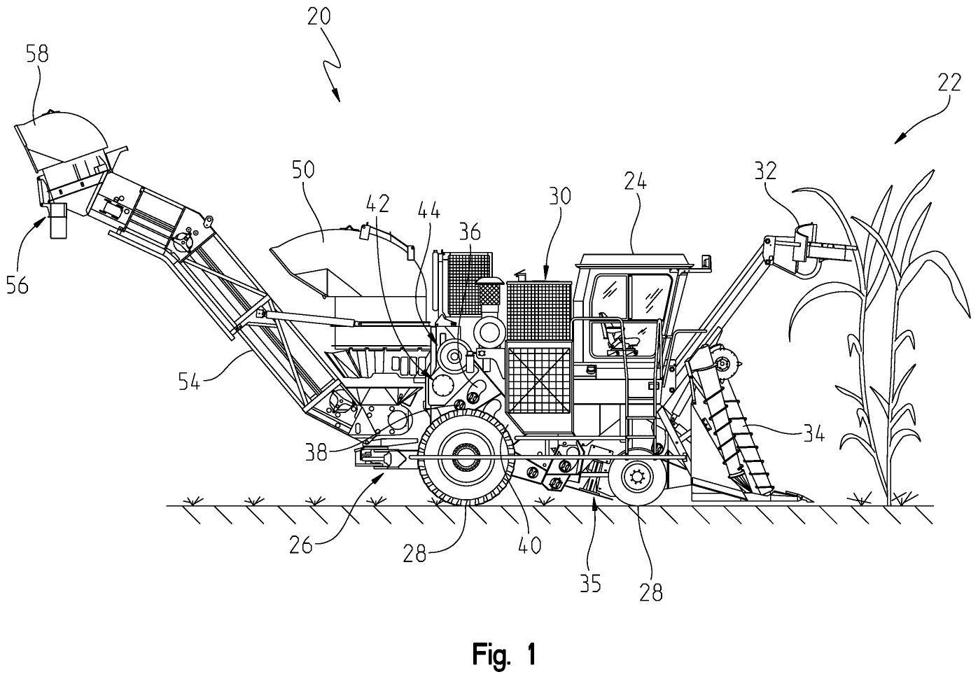

FIG. 1 illustrates a side view of a sugarcane harvester 20 adapted to cut sugarcane 22, with the front of the harvester 20 facing to the right. Accordingly, certain components of the harvester 20 may not be visible in FIG. 1. The harvester 20 includes a cab 24 located on a main frame 26 that is supported by wheels 28 configured to move the harvester along rows of sugarcane 22. An engine, located within a housing 30, moves the wheels 28 along a field to continually cut the sugarcane 22 for harvesting. In different implementations, the engine also powers various driven components of the harvester 20. In certain implementations, the engine directly powers one or more hydraulic pumps (not shown) and other driven components powered by the hydraulic motors via an embedded hydraulic system (not shown).

A cane topper 32 extends forward of the frame 26 in order to remove the leafy tops of sugarcane plants 22. A set of crop dividers 34 guides the stalks of sugarcane toward internal mechanisms of the harvester 20 for processing. As the harvester 20 moves across a field, sugarcane plants passing between the crop dividers 34 are deflected downward by one or more knockdown rollers before being cut near the base of the plants 22 by a base cutter assembly 35, as would be understood by one skilled in the art. Rotating disks, guides, or paddles (not shown) on the base cutter assembly further direct the cut ends of the plants upwardly and rearward within the harvester 20 toward successive pairs of upper feed rollers 36 and lower feed rollers 38. The feed rollers 36 and 38 are supported by a feed roller chassis 40 which is supported by the main frame 26. The upper and lower feed rollers 36 and 38 convey the cut sugarcane crop, that includes stalks as well as dirt, leaves, roots, and other plant matter, which is collectively referred to herein as extraneous plant matter, or crop residue. The conveyed cut crop, which may be in the form of a mat, is directed toward a chopper drum module 42 that chops the mat of cut crop into a chopped mat that includes billets. and crop residue (e.g., leafy material, such as leaves, roots, and field debris etc.) The chopper drum module 42 is also identified herein as the chopper.

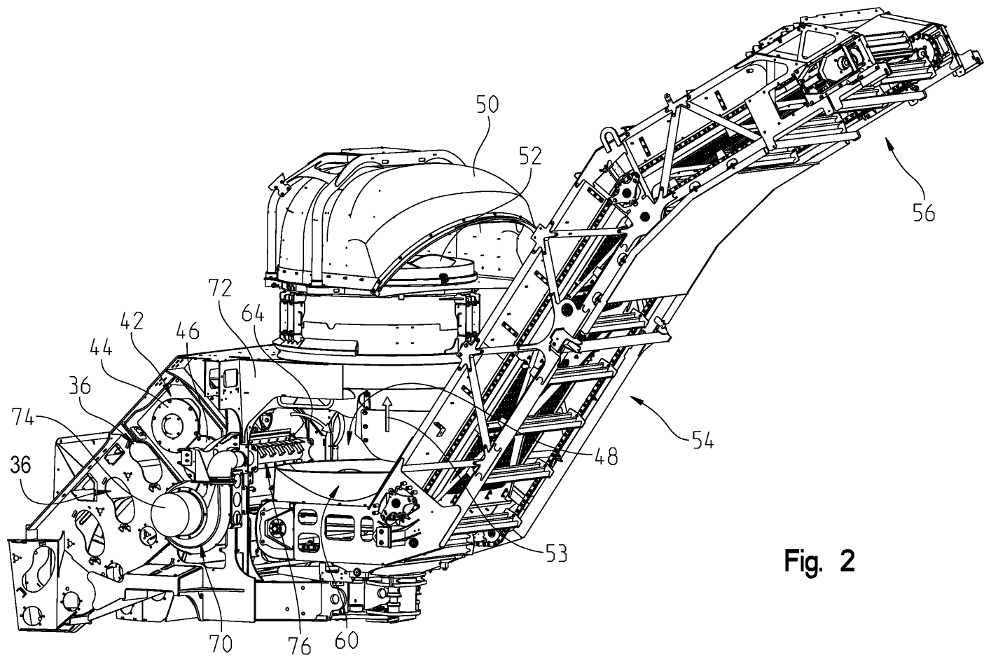

As seen in FIG. 2, the chopper drum module 42 includes an upper chopper drum 44 and lower chopper drum 46 that rotate in opposite directions and, in one implementation, includes counter rotating drum cutters with overlapping blades. The upper chopper drum 44 and the lower chopper drum 46 chop the moving stalks into billets, as would be understood by one skilled in the art. The chopped mat, that includes billets and chopped crop residue, is then propelled or discharged into a cleaning chamber 48 that is located at the base of a primary extractor 50. The primary extractor 50, in different implementations, includes a fan assembly 52, including a powered fan to produce an airflow. In one implementation, the airflow produced by the fan cleans the billets by removing the crop residue, including leafy matter, trash, and debris from the billets. The crop residue is generally directed upwardly along a direction 53.

The cleaned billets, which are generally heavier than the crop residue, fall toward a basket 60. A loading elevator 54, with a one end located at the bottom of the cleaning chamber 48 and adjacent to the basket 60, conveys the cleaned billets upward to a discharge location 56, below a secondary extractor 58 (see FIG. 1), where the billets are discharged into a truck, a wagon, a container, or other receptacle that collects the discharged billets.

As further shown in FIG. 2, the cleaning chamber 48 includes the basket 60 located below the fan assembly 52. As the fan assembly 52 rotates, the crop residue, which is lighter than the billets, is moved in the upward direction 53 by the fan assembly 52 and discharged from the primary extractor. The billets are extracted from crop residue and are conveyed by the loading elevator 54 to the discharge location 56.

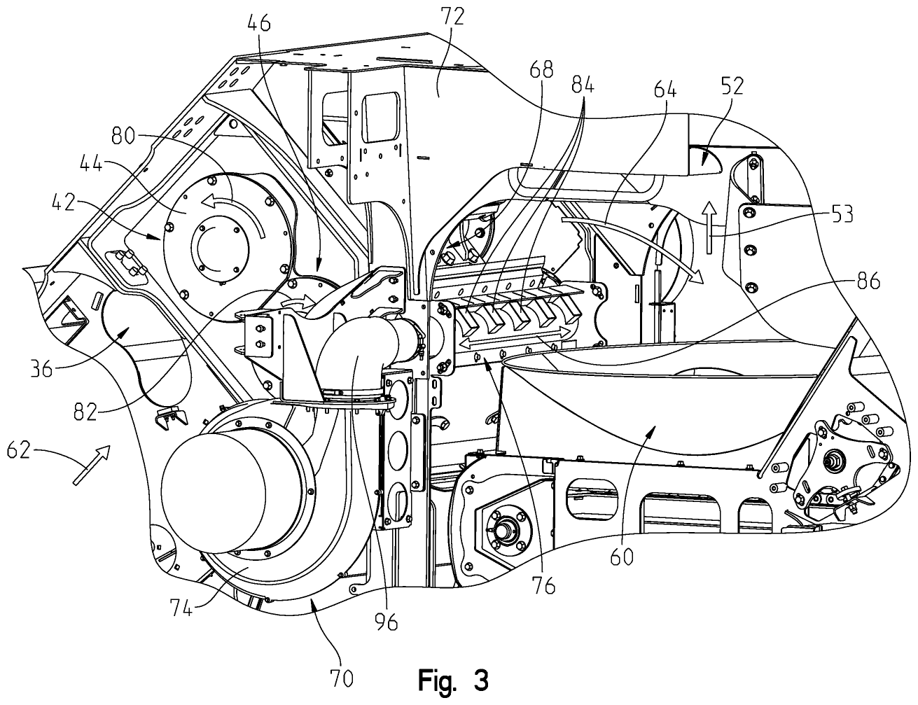

The sugarcane stalks, cut by cutter assembly 35, are moved along a direction 62 (see FIG. 3) by the upper and lower feed rollers 36 and 38 toward the upper chopper drum 44 and the lower chopper drum 46, where the stalks are cut into billets The cut billets, as well as the crop residue, are directed from an outlet 68 of the chopper drum module 42 past the upper chopper drum 44 and lower chopper drum 46 along a direction 64. (See FIG. 3.) The directed billets and crop residue pass above a blower nozzle system 70 before being directed above and toward the basket 60, by the blower nozzle system 70. The blower nozzle system 70, in one or more implementations, provides a supplemental air flow in addition to the airflow produced by the fan 52.

In one implementation, the blower nozzle system 70 is supported by and coupled to a frame 72, which also supports the primary extractor 50. The blower nozzle system 70 includes a blower 74 located adjacently to the outlet 68 on a first side of the frame 72. A blower manifold 76 is operatively connected to the blower 74 and extends along the outlet 68, between the first side of the frame 72 and a second side of the frame 72. The blower 74 provides pressurized air flow to the blower manifold 76. In one implementation, the blower manifold 76 extends substantially across a width of the outlet 68. In other implementations, the blower manifold 76 includes a plurality of manifolds. The blower manifold 76 is located between the chopper 42 and the cleaning chamber 48. In one implementation, the blower 74 provides an airflow of between 500 cubic feet per minute (CFM) and 3000 CFM. In another implementation, the blower 74 provides an airflow of between 1000 CFM to 2000 CFM.

The supplemental air flow directed by the blower manifold 76 is directed toward the sugarcane billets and crop residue which are directed to the cleaning chamber 48. The fan 52, which produces a primary air flow, is configured to lift the crop residue toward the fan 52. In some conditions, however, the primary air flow is insufficient to provide a preferred or adequate amount of cleaning of the materials located within or at the cleaning chamber 48. The manifold air flow provides a supplemental airflow to assist in lifting the material that is not effectively impacted by the primary air flow. The supplemental airflow also provides a desired turbulent airflow to the crop material to further assist separating the crop debris, including leafy material, from the billets.

The rotating chopper drum 44 and rotating chopper drum 46 counter rotate with respect to one another in respective rotational directions 80 and 82. Due to this counter rotation, billets and crop debris are moved by the chopper drums with a force along the direction 64. Due to the weight of the billets and debris, billets and debris follow a curved path along direction 64 down toward the basket 60. To assist the flow of the billets and debris, the blower manifold 76 includes a plurality of nozzles 84 aligned along a longitudinal direction or manifold axis 86. In addition, the blower manifold 76 assists in separating crop debris from the billets. In one implementation, the plurality of nozzles 84 is arranged as a single row of nozzles along the axis 86. In other implementations, the plurality of nozzles 84 are arranged as two or more rows.

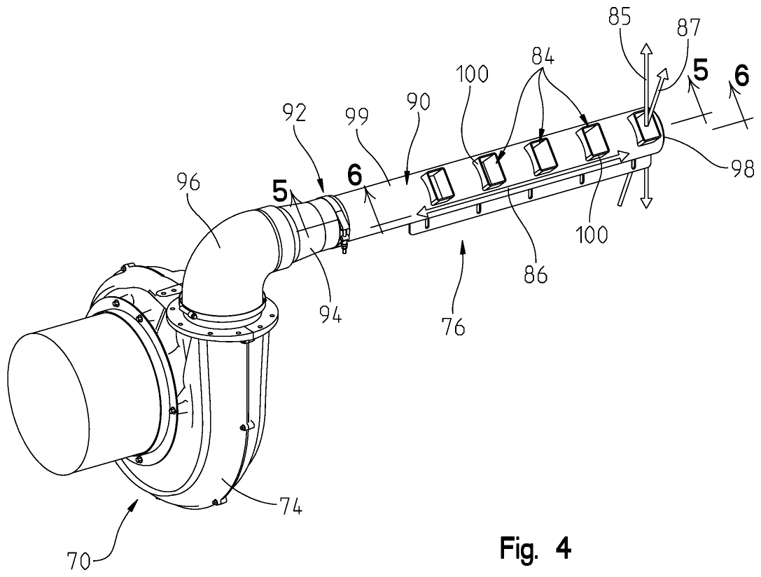

As seen in FIG. 4, the blower manifold 76 of the blower nozzle system 70 includes a cylindrical plenum 90. The plurality of nozzles 84 is included on or defined by the cylindrical plenum 90. The cylindrical plenum 90 includes a length extending along the longitudinal direction 86. A first end 92 of the cylindrical plenum 90 includes a diameter configured to couple to a straight connector 94. The straight connector 94 is coupled to an elbow connector 96. The elbow connector 96 is coupled to an outlet of the blower 74. In other implementations, the straight connector 94 and the elbow connector 96 are a one piece connector. In a further implementation, the blower 74 includes a housing having a connector to couple directly to the manifold 76. A second end 98 of the manifold 76 is closed and terminates the cylindrical plenum 90 to direct air within the cylindrical plenum 90 through the nozzles 84.

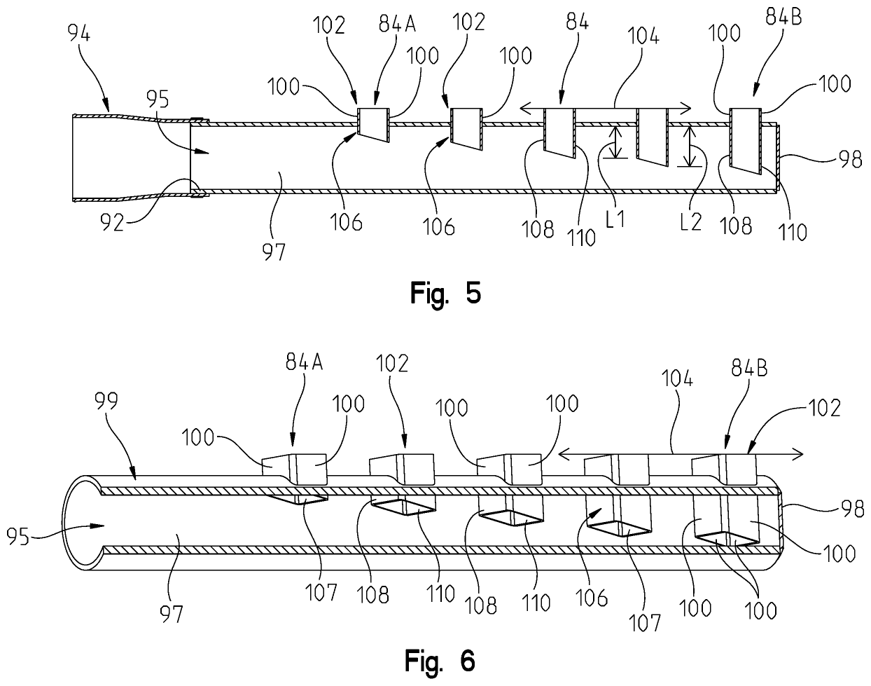

In one implementation, the cylindrical plenum 90 includes a cylinder defining an inlet 95 and an interior space 97. (See FIGS. 5 and 6). The cylindrical plenum 90 includes a cylindrical and constant cross-section along its length from the first end 92 to the second end 98. Air flow from the blower 74 enters the first end 92 and exits each of the nozzles 84 in response to the end 98 being a closed end. The general orientation of the nozzles is to face the crop flow moving along the direction 64. In one implementation, the direction of the airflow of each of the nozzles 84 is inclined with respect to a generally vertical axis 85 as seen in FIG. 4. The airflow, instead of being directly generally upward in the direction 53, is inclined in a forward direction 87 toward the elevator basket 60 due to the inclined orientation of the nozzles 84. In this way, the airflow moves the billets and crop debris toward the upwardly directed airflow 53 made by the fan 52.

The cylindrical plenum 90 includes a convex outside surface 99 from which each of the nozzles 84 extend. A single row of nozzles 84 are generally aligned along the longitudinal direction or axis 86. Each of the nozzles 84 defines a rectangular channel defined by sidewalls 100. In one implementation, the nozzles 84 each include four sidewalls 100 defining a rectangular opening which directs airflow delivered to the cylindrical plenum 90. As seen in FIGS. 5 and 6, each of the nozzles 84 defines a rectangular aperture. In other implementations, the nozzles 84 include other configurations. For instance in one or more implementations, the nozzles 84 include elliptical apertures, oval apertures, or square outlets. the configuration are contemplated including those configurations that provide a uniform airflow along the plurality of nozzles aligned along the plenum. In some implementations, the number of nozzles aligned along the length of the plenum include a range of 5 to 10 nozzles. Other numbers of nozzles are contemplated based on the length of the plenum being used.

As illustrated in FIG. 5, each of the sidewalls 100 of each of the nozzles 84 extends into the interior space 97. A first end 102 of the nozzles 84 extends externally from the convex outside surface 99. The first ends 102 of each of the nozzles 84 include an external terminating edge which defines an external plane 104 along the first ends 102 The external plane 104 is generally parallel with a surface of the convex outside surface 99.

Second ends 106 of each of the nozzles 84, located within the interior space 97, define interior apertures 107. The interior apertures 107 define an inclined aperture having a terminating edge inclined with respect to the external plane 104. For each second end 106, a first sidewall 108, located within the interior space 97, includes a first length, L1. A second sidewall 110, located within the interior space, includes a second length L2. For each nozzle 84, the first length L1 of the first sidewall 108 is shorter than the second length L2 of the second sidewall 110. In this implementation, first sidewalls 108 of each of the second ends 106 are closer to the inlet 95 when compared to the second sidewalls 110. Consequently, each of the second sidewalls 110 receives a flow of air and directs the flow of air upward and into each of the nozzles 84.

The second length L2 of each of the second sidewalls 110 includes a length longer than the length of the second sidewall 110 of the nozzle 84 that is closer to the inlet 95. Consequently, second ends 106, closer to the closed end 98, are longer than an adjacent second end 106 of another nozzle 84, which is closer to the inlet 95. The increasing length of second ends 106 of the nozzles 84 proceeding from a first nozzle 84A, closest to the inlet 95, to a second nozzle 84B, closest to the end 98, provides a relatively uniform flow of air from each of the nozzles 84. The supplemental air flow directed by the blower manifold 76 is relatively uniform across its length to supplement airflow provided by the fan assembly 52. Separation of crop residue from billets in the chopped mat is further facilitated when applied in combination with the primary air flow maintained by the fan assembly 52.

The air flow from each of the nozzles 84 generates a curtain of air having an initial width equal to about the distance between the first nozzle 84A to the last nozzle 84B. As the curtain of air moves further away from the nozzles, the width of the curtain of air expands such that a width between the outer edges of the curtain expands. Initially, the air flow delivered from each of the nozzles, does not overlap an air flow from an adjacent nozzle. At a predetermined distance from the row of nozzles, the air flow of adjacent nozzles begins to overlap and a curtain of air is continuous along its length. Consequently, the nozzles are arranged to achieve a constant and/or average airflow along the length of the array of nozzles. In one or more implementations, a laminar airflow is provided which is uniform in both direction and velocity.

While exemplary implementations incorporating the principles of the present disclosure have been described hereinabove, the present disclosure is not limited to the described implementations. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A sugarcane harvester for harvesting a sugarcane crop comprising:
a chopper defining a chopper axis, the chopper configured to cut a mat of sugarcane crop into a chopped mat including sugarcane billets and crop residue and to discharge the chopped mat along a flow path;
a primary separator including a cleaning chamber and a fan to induce a primary flow of air within the cleaning chamber, wherein the primary flow of air separates crop residue from the sugarcane billets of the chopped mat; and
a supplemental air system located between the chopper and the primary separator, the supplemental air system including a manifold including a constant cross-section along a length of the manifold, wherein the manifold is configured to provide a manifold air flow directed toward the flow path of the chopped mat, wherein the manifold air flow supplements the primary flow of air within the cleaning chamber to separate the crop residue from the sugarcane billets.

2. The sugarcane harvester of claim 1 wherein the supplemental air system includes a blower coupled to an inlet of the manifold to deliver pressurized air to the manifold to provide the manifold air flow, wherein the manifold directs the pressurized air delivered by the blower to the cleaning chamber.

3. The sugarcane harvester of claim 2 wherein the chopper includes counter rotating drums defining the chopper axis, wherein the manifold includes a manifold axis located generally parallel to the chopper axis.

4. The sugarcane harvester of claim 3 wherein the manifold includes a plenum having a cylinder defining an interior space including the constant cross-section and including a convex outside surface.

5. The sugarcane harvester of claim 4 wherein the manifold includes a plurality of nozzles extending from the convex outside surface, wherein each of the nozzles is aligned along the manifold axis.

6. The sugarcane harvester of claim 5 wherein each of the nozzles includes a rectangular channel having a first end extending externally from the convex outside surface and a second end extending into the interior space.

7. The sugarcane harvester of claim 5 wherein the first end of each of the nozzles incudes one of a rectangular aperture, an elliptical aperture, and oval apertures, or a square aperture, having an external terminating edge.

8. The sugarcane harvester of claim 7 wherein the rectangular aperture of the first end defines an external plane and the plane is generally parallel to the manifold axis.

9. The sugarcane harvester of claim 8 wherein the second end of each of the nozzles includes a rectangular aperture having an internal terminating edge located within the cylinder, wherein the internal terminating edge is inclined with respect to the manifold axis.

10. The sugarcane harvester of claim 9 wherein the rectangular aperture of the second end defines a plane inclined with respect to the manifold axis.

11. The sugarcane harvester of claim 10 wherein the second end of each of the nozzles includes a first side wall having a first length and a second sidewall having a second length longer than the first length, wherein the first side wall is closer to the inlet of the manifold than the second side wall.

12. A blower nozzle system for a sugarcane harvester including a cleaning chamber to clean chopped sugarcane and a chopper configured to discharge a chopped sugarcane mat along a flow path to the cleaning chamber, the blower nozzle system comprising:
a manifold including a constant cross-section along a length of the manifold, wherein the manifold is configured to provide a manifold air flow directed toward the flow path of the chopped sugarcane mat, wherein the manifold air flow supplements a primary flow of air within the cleaning chamber to separate crop residue from the sugarcane billets of the chopped sugarcane mat, wherein the manifold is configured to provide a manifold air flow directed toward the flow path of the chopped sugarcane mat to separate the crop residue from the sugarcane billets.

13. The blower nozzle system of claim 12 wherein the manifold includes a plenum having a cylinder defining an interior space including the constant cross-section and including a convex outside surface.

14. The blower nozzle system of claim 13 including a plurality of nozzles extending from the convex outside surface, wherein each of the nozzles is aligned along the manifold axis.

15. The blower nozzle system of claim 14 wherein each of the nozzles includes a rectangular channel having a first end extending externally from the convex outside surface and a second end extending into the interior space.

16. The blower nozzle system of claim 15 wherein the first end of each of the nozzles incudes a rectangular aperture having an external terminating edge.

17. The blower nozzle system of claim 16 wherein the rectangular aperture of the first end defines an external plane and the plane is generally parallel to the manifold axis.

18. The blower nozzle system of claim 17 wherein the second end of each of the nozzles includes a rectangular aperture having an internal terminating edge located within the cylinder, wherein the internal terminating edge is inclined with respect to the manifold axis.

19. The blower nozzle system of claim 18 wherein the rectangular aperture of the second end defines a plane inclined with respect to the manifold axis.

20. A method for separating crop residue from sugarcane billets in a cleaning chamber of a sugarcane harvester comprising:
chopping a mat of harvested sugarcane into a chopped mat including the sugarcane billets and the crop residue, wherein the chopped mat moves along a flow path toward the cleaning chamber;
directing a supplemental flow of air toward the flow path of the chopped mat with a manifold having a constant cross-section along a length of the manifold; and
separating billets from crop residue in the cleaning chamber with the supplemental flow of air and with a primary flow of air provided by a fan located adjacent to the cleaning chamber.
